(19) United States
(12) Patent Application Publication
(10) Pub. No.: US 2017/0013408 A1
(43) Pub. Date: Jan. 12, 2017

(54) User Text Content Correlation with Location

(71) Applicant: JAGUAR LAND ROVER LIMITED, Coventry, Warwickshire (GB)

(72) Inventors: Adam Grzywaczewski, Coventry, Warwickshire (GB); Lech Birek, Coventry, Warwickshire (GB); Adam Gelencser, Coventry, Warwickshire (GB)

(21) Appl. No.: 15/115,797

(22) PCT Filed: Feb. 4, 2015
(86) PCT No.: PCT/EP2015/052323

§ 371 Date: Aug. 1, 2016

(30) Foreign Application Priority Data
Feb. 4, 2014 (GB) 1401889.9
Jul. 8, 2014 (GB) 1412167.7

(51) Int. Cl. H04W 4/02; G06N 99/00

(52) U.S. Cl. CPC H04W 4/028; G06N 99/005; H04W 4/046

(57) ABSTRACT

A predictive modelling system for predicting location data from user textual data comprising: an input for receiving user data, the user data comprising user textual data and location data; a pre-processing module arranged to correlate user textual data with location data to form a set of correlated data; a training module arranged to use the set of correlated data to train a machine learning algorithm such that the algorithm is arranged to output predicted location data from an input textual query.

### TECHNICAL FIELD

The present invention relates to user content analysis and in particular, but not exclusively, relates to a method of analysing content created by or relating to a user in order to create a predictive model relating user generated content to geographical locations. Aspects of the invention relate to a system, to a module, to a vehicle and to a method.

### BACKGROUND

The proliferation of Internet and mobile technologies has significantly changed the way people communicate with each other. Additionally, the use of digital resources such as electronic/mobile calendars, email, text messaging and web services such as Facebook, Twitter, LinkedIn, Foursquare, Google Latitude means that, for a given individual, a significant amount of location and time information is maintained in electronic resources. Digital calendars describe in detail the locations that an individual will visit in the future. Further location information is available through the sharing of information on social media, such as Facebook and the publishing of geo-tagged photos on Flickr.

Historically, the task of interpreting written text in order to extract geographical information was based on the notion of gazetteers. Gazetteers are static dictionaries listing all possible geographical locations and potentially their coordinates. One of the key limitations of the above-mentioned approach is the fact that gazetteers are, by nature, fixed and are unable to capture user specific means of describing location, e.g. colloquial names. This makes the interpretation of written text in order to predict future destination a non-trivial task.

Being able to predict where the user will be located in several minutes, hours, days and weeks is an enabler for delivery of multiple technologies. Similarly, the ability to learn user geographical vocabulary is an enabler for the design of new user interfaces and interaction context sensitive utilities. The potential of high accuracy destination identification and prediction is significant not only in the automotive industry but in a wider IT.

Unfortunately the interpretation of written text in order to identify geographical information is complex. Humans, especially when interacting with other people rarely use the official administrative vocabulary and often rely on the context of conversation and past relations with people in order to describe their intentions.

For example two students may discuss on a social media site such as Twitter their plans to meet at the “uni”. This is sufficient for them not only to identify the continent, country, and the name of the university they are referring to, but also in many instances the reference to “uni” will refer to a certain physical location within the campus itself.

To make matters even more complex, people refer to places using local, very often private and colloquial, vocabulary that does not have any meaning outside of their particular social context.

For example, two friends who are discussing a meeting in “Cambridge” will have no issues identifying that they are both referring to “The Duchess of Cambridge” pub in London where they meet on a regular basis and not to Cambridge, Mass. or Cambridge, England.

People use a significant variety of colloquialisms and neologisms in order to describe their location and a proportion of these are unique to small groups of individuals or are work environment specific. People think in a functional manner, frequently describing goals and tasks with strong geographical connotations without referencing the location directly. Additionally mistakes may be made when describing their activities and a person's or group's naming convention for places can change over time as well.

It is known to use data pertaining to a user's regular activities to automatically generate and present to the user information that might be of interest to them. Such arrangements use the current date and time as an input, and attempt to match that against previously identified regular journeys.

For example, some systems monitor user journeys to identify routine trips, such as a commute to and from work. Then, on detecting that the user is about to commence one of the identified regular trips, based on the current date and time, the system generates relevant information for the user such as traffic alerts on the expected route.

It is also known to use calendar appointments to provide journey alerts containing information relevant to an appointment, such as current traffic conditions or public transport status. An example of a system that does this is the ‘Google Now’ application. However, this application relies on the user to include precise location data in the calendar appointment; if the location information is vague or ambiguous, the problems outlined above in interpreting the location data may prevent the application from identifying the correct destination.

In the context of the available technology described above, there is a desire to mitigate or overcome the above-mentioned problems with geo-parsing user data, and to enhance systems relating to regular activities by making use of geo-parsing user data. It is against this background that the present invention has been devised.

### SUMMARY OF THE INVENTION

According a one aspect of the present invention there is provided a predictive modelling system for predicting location data from user textual data comprising: an input for receiving user data, the user data comprising user textual data and location data; a pre-processing module arranged to correlate user textual data with location data to form a set of correlated data; a training module arranged to use the set of correlated data to train a machine learning algorithm such that the algorithm is arranged to output predicted location data from an input textual query.

This aspect of the present invention provides a system in which user location data and user textual data may be used to train a predictive modelling system such that further user related textual data may be input into the system in order to output a likely location for the user. The knowledge of a user's future location can help in planning bandwidth requirements for the mobile network operators, can be used to prepare multimedia on user tablet/smartphone or allow for hybrid car electric engine use and battery charging optimisation or negotiation of better electricity rates.

Optionally, user data may be received from a user calendar and from a global positioning system (GPS)-enabled device. GPS-enabled devices may comprise a mobile communications devices (such as smartphones like the iPhone® or Android mobile communications devices or tablets such as the iPad® or Samsung Galaxy® Tab) or may comprise a GPS-enabled vehicle.

The pre-processing module may be arranged to cluster received location data into a plurality of cluster centres. The pre-processing module may be further arranged to merge clusters of received location data in the event that the given cluster centres are within a predefined proximity to one another.

The pre-processing module may be arranged to class location data into fixed location categories and journey route categories. The pre-processing module may be further arranged to remove specific location data points in the event they have been classified as being part of a user journey route.

The training module may be arranged to train the machine learning algorithm by dividing fixed location categories into two groups, the first group comprising the most popular fixed location category and the second group comprising all remaining categories, in order to reduce data skewing during training.

Optionally, the training module may be arranged to split the set of correlated data into a training portion for training the machine learning algorithm and a verification portion for verifying the accuracy of the trained machine learning algorithm.

The training module may be arranged to train the machine learning algorithm to optimise the identification of local minima in the user data.

The machine learning algorithm may output predicted location data and a confidence level associated with the prediction.

According to another aspect of the present invention there is provided a system for predicting location data from user textual data comprising: an input for receiving user data, the user data comprising user textual data; a machine learning algorithm arranged to predicted location data from an input textual query, the algorithm having been trained on a set of correlated data comprising user textual data and location data; an output arranged to output the predicted location data for the user based on the received user textual data.

This aspect of the present invention may comprise, where appropriate, the features of the foregoing aspect of the present invention.

The invention extends to a mobile network bandwidth planning system comprising a predictive modelling system according to the foregoing aspects of the invention and to a hybrid car (traction) battery charge management module according to the aspects of the invention described herein before. As explained above, knowledge of a user's future location can help in planning bandwidth requirements for the mobile network operators, can be used to prepare multimedia on user tablet/smartphone or allow for hybrid car electric engine use and battery charging optimisation or negotiation of better electricity rates. For example, in one embodiment, a mobile network bandwidth planning system may allocate bandwidth associated with a cell of a cellular communications network in dependence on the predicted location of a user as determined by the predictive modelling system. In particular, a request for bandwidth associated with a particular cell may be sent in advance of a device belonging to the user (such as a mobile phone or tablet device, or a vehicle) entering the cell, in dependence on a determination that the user is predicted to be within the cell in the future. Similarly, in another embodiment, a hybrid car (traction) battery charge management module may be operable to control the use of the traction battery during a journey of a vehicle, in dependence on the predicted destination as determined by the predictive modelling system.

In particular, in dependence on a determination by the predictive modelling system that a user's future location will coincide with a charging event (such as a prediction that the user is returning home at the end of a day), the battery charge management module may be operable so as to minimise the charge of the traction battery when the journey is completed.

According to a further aspect of the present invention there is provided a method of training a machine learning algorithm comprising: receiving user data, the user data comprising user textual data and location data; correlating user textual data with location data to form a set of correlated data; using the set of correlated data to train a machine learning algorithm such that the algorithm is arranged to output predicted location data from an input textual query.

According to an aspect of the invention, there is provided a predictive modelling system for predicting a current destination from a combination of user data and activity data. The system comprises an input for receiving user data and activity data. The system further comprises a user data processing module arranged to determine at least one non-routine event from the user data, the or each non-routine event being defined by a respective event time and a respective predicted event location derived from a non-specific location reference included in the user data. The system also includes an activity data processing module arranged to determine at least one routine event from user activity data, the or each routine event being defined by a respective event time and a respective event location.

The system is arranged to compare the or each event time against a current time input to determine a current event, and to use an event location or predicted event location corresponding to the current event to determine the predicted current destination.

The events that are identified by the predictive modelling system may be, for example, meetings or appointments or other commitments that the user is due to attend.

In this context, a ‘routine event’ is a regular commitment, for example commencement of a working day for a job with a regular working pattern. In this case, the event time is the user's usual arrival time at work, and the event location is the user's place of work. These parameters can be determined by the activity data processing module by analysing data captured during the user's regular morning commute to work, for example data from a GPS system.

In contrast, a ‘non-routine event’ represents meetings, appointments or other commitments and arrangements that do not occur according to a regular pattern. Details of such events cannot be obtained through analysis of previous data, and must instead be derived from another source such as textual user data created by the user, for example user data received from a digital calendar. As noted previously, if the location of such events is specified exactly it is straightforward to determine the event parameters, and known systems are able to do this. However, if the location is defined using a non-specific location reference, as in the above example where “Cambridge” is used to refer to a pub rather than to a city, the known systems would not be able to determine the event location. For such events, the user data processing module is provided to interpret the non-specific reference to identify the location.

Therefore, the predictive modelling system according to this embodiment is able to determine both regular events and non-routine events defined by an ambiguous location reference. This beneficially increases the likelihood that the system will be able to identify an event corresponding to a current time input, and therefore predict the user's destination. The ability to predict the user's destination enables the system to prompt presentation of relevant information and alerts that the user is likely to be interested in, and so the ability to do this more often provides a clear benefit.

Occasionally, there may be a conflict between a routine event and a non-routine event. For example, the user may have booked an appointment with their doctor at a time that they would ordinarily start work. To accommodate this, the system may be arranged such that if both a non-routine event time and a routine event time substantially match the current time input, the event location corresponding to the non-routine event is used to determine the predicted destination.

The term ‘substantially match’ is intended to cover event times that are close enough to one another that it would be impractical for the user to attend both the routine event and the non-routine event. This includes identical event times, and also event times that are, for example, within 30 minutes of one another. This tolerance can be adjusted as desired, and could even be dynamically controlled to account for the distance between the respective locations of each event; if the two events are close together geographically, a relatively small time difference may be acceptable, whereas events spaced further apart geographically will be considered to conflict for a greater range of start times. For example, if the user has an appointment at a location 100 miles away from their usual place of work and booked for one hour later than their normal arrival time at work, it is unlikely that the user will go to work first.

This prioritisation beneficially provides a default choice for the system, providing consistency in the handling of instances of conflict. Moreover, this approach ensures that the user's personal data is prioritised over data that is gathered by tracking of the user. Since the user has direct control over the user data, for example a calendar entry, this allows the system to be responsive to user input.

The system may comprise presentation means in the form of a presentation module arranged to present to a user information relevant to the predicted destination and/or to a route to the predicted destination from the user's current location.

To aid in interpreting ambiguous location references, the system may be arranged to correlate the or each non-specific location reference with location data included in the user data in order to determine the or each predicted event location. This typically entails cross-referencing a location reference contained in the user data with previous instances of the same location reference being used, and determining from location data a destination that the user navigated to on those previous occasions. This destination can then be matched with the non-specific location reference. In this way, the system can learn precise destinations for non-specific location references over time.

In view of this, it will be appreciated that for the user data processing module to be able to interpret a non-specific location reference accurately, the user must have used the reference on at least one previous occasion. Furthermore, location data must available for this previous occasion. Therefore, it may not always be possible to derive a predicted event location from a non-specific location reference.

To account for this, the system may be further arranged to return a null result for the predicted destination if the user data processing module is unable to derive a predicted event location from a non-specific location reference associated with an event time substantially matching the current time input due to a lack of location data. This beneficially suppresses a predicted destination based on a routine event in cases of conflict, ensuring that the user is never presented with alerts or information relating to routine events at a time where a non-routine event has been booked, even if the location of the non-routine event cannot be predicted.

In one embodiment, the user data processing module comprises a pre-processing module arranged to correlate a non-specific location reference with location data included in the user data to form a set of correlated data, and a training module arranged to use the set of correlated data to train a machine learning algorithm such that the algorithm is arranged to output predicted location data from an input non-specific location reference.

User data may be received from a global positioning system (GPS) enabled device, such as a mobile communications device, a vehicle, or a combination of the two, for example.

Conveniently, the system may be implemented in an application for a mobile communications device. In such embodiments, the invention also extends to a vehicle arranged to communicate with the application.

In another aspect of the invention, there is provided a method of predicting a current destination. The method comprises receiving user data and activity data, determining at least one non-routine event from the user data, the or each non-routine event being defined by a respective event time and a respective predicted event location derived from a non-specific location reference included in the user data, and determining at least one routine event from user activity data, the or each routine event being defined by an event time and an event location. The method further comprises comparing the or each event time against a current time input to determine a current event, and using an event location or predicted event location corresponding to the current event to determine the predicted destination.

Further aspects of the invention provide: a computer program product comprising computer readable code for controlling a computing device to perform the above described method; a non-transitory computer readable medium loaded with such a computer program product; and a processor arranged to run such a computer program product.

Finally, the inventive concept also embraces a vehicle comprising a system or a processor as described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is an overview of a system according to an embodiment of the present invention;

FIG. 2 is a flow chart of the data processing procedures occurring in the pre-processing module of FIG. 1;

FIG. 3 is an illustration of the various schedule data vs. location data scenarios that can occur.

### DETAILED DESCRIPTION

Embodiments of the present invention provide a system and method for geo-parsing user data and the creation of a “user personalised gazetteer”. Such embodiments may take advantage of the increase in GPS (global position system) capable devices that have Internet connectivity to obtain geographical information relating to a user for subsequent aggregation and processing.

It is noted in this regard that there are now more than a billion smart devices (e.g. smart phones such as iOS, Android and MS Windows devices and tablets such as iPad®, Samsung Galaxy@ Tab etc.) in operation around the world. Additionally services such as Facebook, Google, MS Outlook, Twitter and SMS message systems have billions of users worldwide.

Embodiments of the present invention seek to collect and integrate users' text content with their location data to allow the development of location prediction models that can analyse a user's created text content (e.g. a calendar entry on their smart device) and predict the location of the user.

As described below the present invention provides a mechanism for a predictive model to “learn” a user's particular vocabulary from their historical movements and textual content.

Once the gazetteer/model has been created it can be applied to interpret any other textual data. For example, to return to the scenario discussed above where student A is talking to student B about the meeting in the “uni” the learning model according to the present invention would be able to infer from the exchange that the two students will be meeting at a certain point of a certain university (with certain confidence level). Similarly the system would be capable of understanding that in the context of this particular conversation that ‘Cambridge’ relates to a pub and not a city in USA.

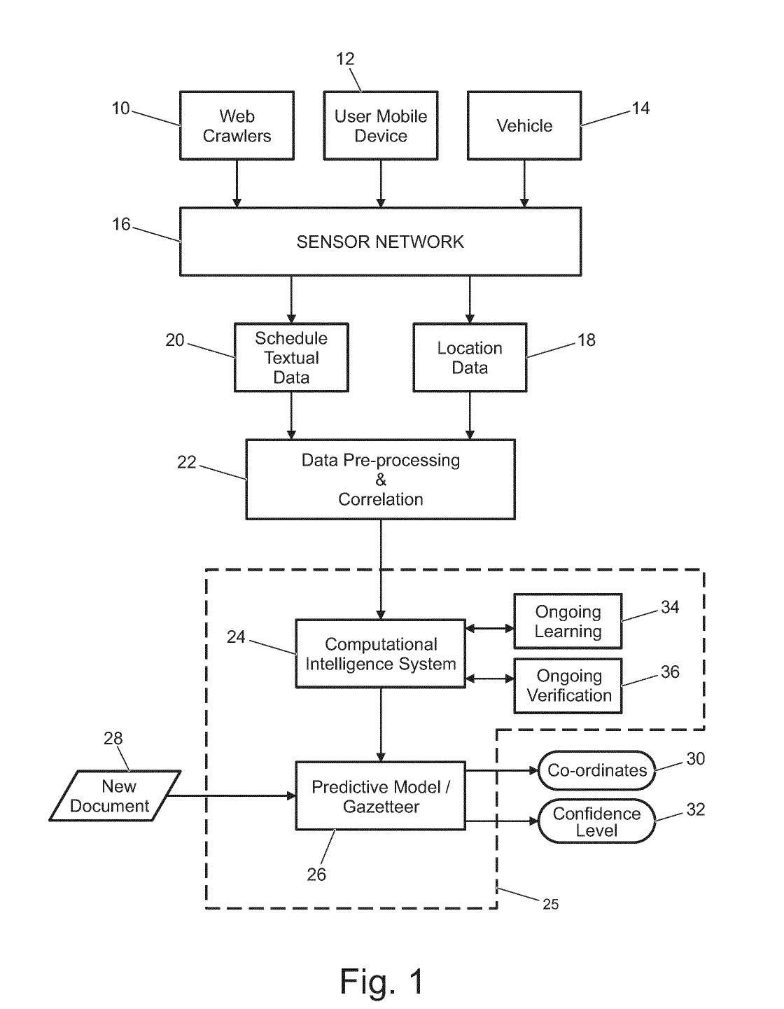

FIG. 1 shows a high level overview of a system according to an embodiment of the present invention. It can be seen that the system comprises a sensor network 16, pre-processing module 22, classification module 24 and predictive module 26.

In the following description it is noted that the modules 24 and 26 relate to the same general feature and may be thought of as “before” and “after” versions of a predictive model.

Classification module 24 corresponds to a pre-trained model which is then trained with user data to result in a predictive model that can be used to classify new data. The process of training the model would be relatively expensive and so that model would probably not be retrained every time new data is available. Instead the model could be retrained (or be subject to further training) on a cycle of n days or weeks. In order to denote the interrelationship between modules 24 and 26 they are shown enclosed by a dotted line 25.

In FIG. 1 content generation modules (10, 12, 14) output content related to a user. In the example of FIG. 1 the content generation modules comprise a web crawler module 10, a mobile telecommunications device 12 and a GPS equipped vehicle 14. The web crawler module 10 may crawl a user's social media content, e.g. Facebook posts and Twitter posts. The mobile communications device 12 may generate both textual content and global positioning system (GPS) data.

A user's geographical location history may be extracted from a dedicated GPS device, e.g. a sat-nay in a car. Additionally or alternatively, GPS data may be received from another source, e.g. a mobile communications device (“smart phone” or “tablet”). GPS data comprises latitude and longitude coordinates and a time stamp of the record, together with a unique user ID which makes it possible to distinguish different users or groups of users between each other.

The content output from the content generation modules (10, 12, 14) may be received via a sensor network 16. The sensor network 16 may be arranged to divide the data into two general categories: location related data 18 (comprising location and associated time stamp data) and textual content data 20.

The textual content data provided to the sensor network 16 conveniently comprises schedule related data, e.g. calendar entries, web crawled posts that discuss meetings/locations.

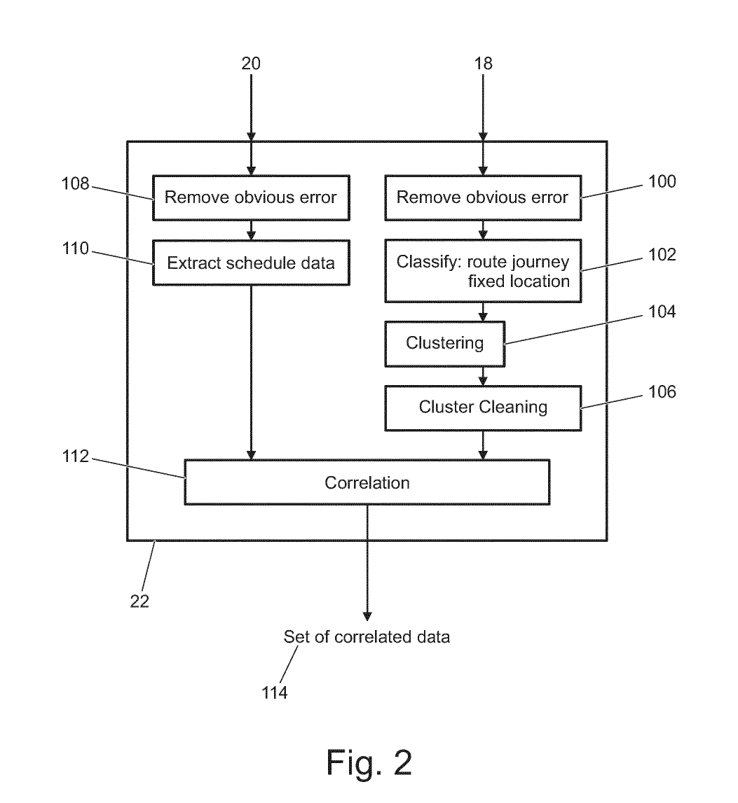

The textual content data 20 and location related data 18 is then passed to the pre-processing module 22 which processes the data in accordance with FIG. 2.

Within the pre-processing module 22 any incorrect/irrelevant data (e.g. rejected meeting requests) or data that cannot be resolved (e.g. missing/incorrect/inaccurate GPS data or conflicting/incorrect meeting information) is either corrected or removed.

The pre-processing module 22 also correlates a relation between the textual data 20 extracted from user schedules and other user content and the location data 18. It is noted that it is important that the pre-processing module is able to correlate textual information as well as the resolution of location data. If the historical information does not correctly reflect the relation of past location to the textual data describing it, the computational intelligence system will not be able to learn the description regularities as they will not exist in the data.

Depending on the source of the location data, it may be necessary for the pre-processing module to pre-process the received location data points. It is often the case that GPS devices produce false or skewered readings due to signal loss caused by proximity of tall buildings or driving through enclosed spaces such as tunnels or multi-storey car parks. Additionally if the source of the GPS signal is the device such as a mobile phone, the GPS transmitter may not be the only component responsible for location tracking. Very often technologies such as Wi-Fi, 3G or other in-built sensors (gyroscopes, accelerometers etc.) are used to enhance the location reading when GPS signal is unavailable, but in turn they introduce other component specific inaccuracies.

Referring to FIG. 2, after an initial clean-up of obvious error points (step 100), the location data points are marked, in step 102, as either being a “route point” (representing movement of the user) or “location points” (where the user is stationary). The location data points are then clustered, in step 104, by the pre-processing module into locations which group them around a single point called a cluster centre. This clustering process results in a structure of cluster centres.

It is noted that obvious location error points may result for a number of different reasons. For example a user may show as being present at two distinct locations as a result of two mobile phones sharing the same account. Additionally where location data is provided from sensors other than the GPS sensor (e.g. mobile network location data) this can result in users who have an apparent motion that is very high (e.g. moving 2 kilometres in less than 1 second) due to lower resolution location data compared to the resolution of GPS data. Other location based errors that can be detected and cleaned up may include a user apparently jumping between parallel and adjacent road streets and delays in a phone's GPS unit being activated for data logging. All of the above obvious errors may be detected and removed via a number of techniques, for example a simple rule based analysis of location data.

The cluster structure is then further reduced, in step 106, by removing groups consisting only of the points classified previously as routes and by merging clusters which may have been created in close proximity to each other.

After these steps an initial network of possible location events is generated based on the remaining clusters and the time the user has spent in the identified locations.

Textual content data 20 comprising schedule related data, e.g. calendar entries, web crawled posts that discuss meetings/locations, is also analysed within the pre-processing module 22 for events which have some contextual information available, such as the description of the location, summary of the event or list of participants of the event. Following the removal of obvious errors in such data (step 108), this information is extracted, and combined into one text document per event (step 110). The removal of obvious errors in the textual content data may comprise resolving typographical errors, analysing calendar events to resolve conflicts, identifying calendar events without associated location data for further processing.

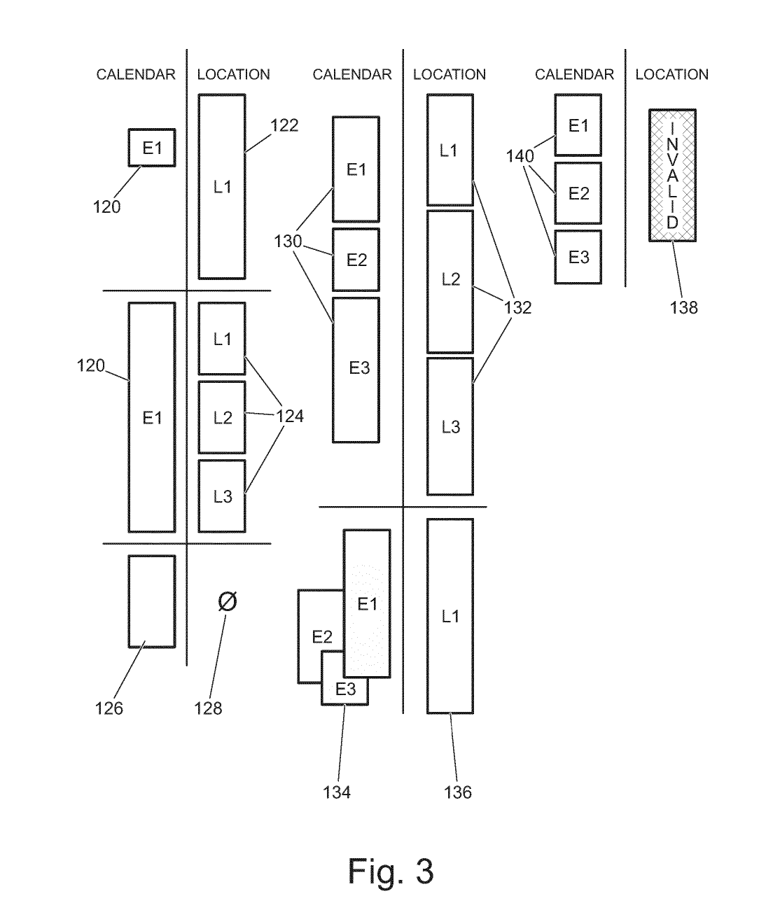

Once the location data and textual data has been pre-processed, the pre-processing module correlates the data in step 112. In this step the pre-processing module checks if any of the identified locations overlap with one or more calendar events. The events which overlap with the locations are chosen as candidates for consideration during an inferring process. There are many scenarios which need to be taken into account when this process occurs. As shown in FIG. 3 there may be instances where a single calendar entry 120 is associated with a single location 122 or multiple locations 124. There may be calendar entries 126 without a discernible location 128 and there may be instances where multiple calendar entries 130 cannot be uniquely associated with particular locations 132. Another scenario is overlapping calendar entries 134 with a single location 136. It is also possible that the pre-processing may be unable to identify a valid location 138 for a set of entries 140.

To be able to provide the reliable training data for the classifier module 24, the pre-processing module is arranged to resolve conflicts between the calendar events and recorded locations, for example when one calendar event is spread between many geographic locations.

The pre-processing module is arranged to resolve conflicts by looking at the time the user has spent at each of the locations during that particular calendar event. In the case of one event and multiple locations, only the location at which the user spent the most time is taken into account. Another important factor is the user's participation intent, i.e. if the user agreed to participate in the event, declined, is not sure about the participation or did not respond to the invite. The declined events are ignored. Other events are further checked for conflicts and are given weights, with the highest being awarded to the events with confirmed participation. This way some of the conflicts between the events can be eliminated before the training data is constructed and fed into the classifier.

Having resolved conflicts in the data, the pre-processing step outputs a set of training data 114 for use in the classifier module 24. The training data takes the form of a series of text documents created from the calendar events with assigned locations.

The set of training data is then input to the classifier module 24 which comprises a machine learning algorithm for building up a predictive model 26 for the user that links textual inputs to location data. The available set of training data is split so that a proportion is used for training the classifier algorithm and the remaining portion is used to validate the accuracy of the trained classification algorithm. For example, 80% of the data may be used for training and 20% for verification.

The trained classifier algorithm is represented as a separate module 26 within FIG. 1, the predictive module 26. New textual data 28 input into the predictive module 26 results in an output of a set of geographic coordinates 30 along with a confidence level 32 in the prediction.

The process of training the model may continue as indicated by the on-going learning 34 and on-going validation 36 modules.

As machine learning methods (e.g. support vector machines) operate on numbers, textual content is converted into numeric representation. In order to do that, the text is further pre-processed within the classifier module 24 (all characters are changed to lower case, the punctuation marks are removed, together with all special signs) and split into tokens (i.e. separate words). In some cases n-grams may be generated, as it also creates all existing combinations of n-words which are positioned next to each other in the sentence.

Having the text space separated into tokens and n-grams, the term frequency/inverse document frequency score may be calculated for all terms in every document and TF-IDF matrix may be created. Each row in the matrix corresponds to a separate document (calendar event) and each column is a separate token (word) or n-gram (combination of n words). The TF-IDF value increases proportionally to the number of times a word or n-gram appears in the document, but is offset by the frequency of the word in the corpus (all documents combined), which helps to control for the fact that some words are generally more common than others.

Singular Value Decomposition (SVD) may then be applied in order to determine the patterns in the relationships between the terms and the concepts contained in the documents. The reduction of the resulting matrix is performed to preserve the most important semantic information in the documents and at the same time to reduce the noise in the original TF-IDF matrix.

The process of converting the text information into a numerical representation and then the pattern recognition with the reduction is called Latent Semantic Indexing (LSI). A key feature of this method is its ability to extract the patterns by establishing associations between the terms that occur in similar contexts.

In order to avoid data skewing during the process of latent semantic indexing the training data may be grouped in such a way as to reduce the effects of such skewing. For example, in a data set there may be a number of locations identified: home, work, shops, sports club etc. Most people spend on average the majority of their time at home. This however tends to skew the results from a support vector machine such that any input data resolves onto the “home” location as that's where an individual spends most of their time. In order to reduce the impact of such data skewing the initial training data may be reclassified as “home” and “not home”. Once the “home” data has been used to train the model, the “not home” data can then be used and a similar reclassification can be used, e.g. “work” and “not work”. The above modifications to the underlying machine learning logic (in other words reclassifying the training data) were introduced to minimise the impact of the skew of the data set on the classification process. In this manner an approach was optimised to identify local optima more effectively (this may also be thought of as using a more “greedy” algorithm—see http://en.wikipedia.org/wiki/Greedy_algorithm)

It is noted that the proposed approach is not only applicable to individual users but may be generalised to wider user populations. By examining the social network of the user (through analysis of Facebook interactions, email conversations, calendar entries, or by looking at a geographic distribution of users, etc.) it is possible to create a hierarchy of user populations with individual geography related vocabulary.

In summary, then, the above described methods use textual user data to derive a list of locations that the user is known to visit. This enables accurate identification of the location of future events listed in a user's calendar. One benefit of this is that, when the time for the event draws near, alerts or other relevant information can be generated and presented to the user to prepare them for their journey. For example, the method could be used in combination with a vehicle navigation system, meaning that when the user enters the vehicle to commence a journey associated with a calendar event, the navigation system can automatically identify the destination and advise the user of traffic delays on the expected route, and suggest alternative routes. Furthermore, the location data can be used to automatically initiate navigation if desired, for example if an alternative route is unfamiliar to the user.

As noted above, some existing systems monitor user activity to derive a list of regular journeys. For example, a GPS-enabled phone or vehicle can track a user walking or driving to and from work at similar times each day, and learn the times and locations associated with the user's commute. Once learned, the phone can automatically generate information for the user relating to their journey. In the case of a vehicle, if the user enters the vehicle at a time corresponding to their morning commute, the system identifies this regular journey and automatically presents to the user traffic information for the route to their work location. The system can suggest alternative routes if necessary, and even automatically initiate navigation along said alternative route in case it is unfamiliar to the user.

In view of the ability of the above described method to determine location data from textual user data, there is an opportunity to enhance the existing systems based on regular journeys to also include non-routine journeys entered into a calendar. The enhanced system can be implemented in a variety of contexts, for example on a smartphone, or in a vehicle. The destination for the non-routine journey may be defined by precise location data included in the calendar, or if the location data is ambiguous and has been used previously, the destination can be derived using the methods outlined above.

Taking the example of a vehicle, the effect of the enhancement is that, on entering the vehicle, the system can determine whether the user is about to commence a routine journey or a journey associated with a calendar event. In either case, the destination can be accurately predicted, and relevant information for the user, such as traffic alerts or navigation for an unfamiliar route, can be generated accordingly.

The enhanced system therefore provides the same functionality as the existing system in terms of providing information concerning regular journeys, but with the additional ability to provide similar information for non-routine journeys.

A conflict may arise if the user has a calendar event booked at a time corresponding to a regular journey. For example, the user may have an appointment to visit a regular client, whose location is known to the system from previous visits, around the same time that they would normally commute into work. In such circumstances, in an embodiment of the present invention a higher priority is assigned to the event marked in the calendar, such that the system assumes that the user is travelling to the location associated with the calendar entry, rather than the location associated with the regular journey. This prioritisation is based on the principle that the calendar event has been actively entered by the user, and so should take priority over data obtained through tracking the user, over which the user has no direct influence.

Therefore, in the illustrative scenario outlined above, the system generates information relating to the appointment with the regular client, and suppresses information pertaining to the regular journey.

It is noted that the above prioritisation applies for all calendar events, whether the location data is ambiguous or not, such that in cases of conflict with regular journeys the system always assumes that the user is travelling to the destination defined in the calendar entry.

Although the enhanced system has been described above as an integrated system, it will be appreciated that alternatively two parallel systems could be implemented: one that handles regular journeys, and another to handle non-regular journeys. In this embodiment, the latter system is given priority in cases of conflict and overrides the system that handles regular journeys. At a programming level, the implication of this is that two separate algorithms would be running: one for regular journeys, and a second analysing calendar events. The outputs from the two algorithms are compared, and the result from the regular journey algorithm is discarded if it conflicts with the result from the calendar algorithm.

Further aspects of the invention extend to the following numbered paragraphs:

1. A predictive modelling system for predicting location data from user textual data comprising:
an input for receiving user data, the user data comprising user textual data and location data;
a pre-processing module arranged to correlate user textual data with location data to form a set of correlated data;
a training module arranged to use the set of correlated data to train a machine learning algorithm such that the algorithm is arranged to output predicted location data from an input textual query.

2. A system as claimed in paragraph 1, wherein user data is received from a user calendar.

3. A system as claimed in paragraph 1, wherein user data is received from a global positioning system (GPS) enabled device.

4. A system as claimed in paragraph 3, wherein the GPS enabled device is a mobile communications device.

5. A system as claimed in claim 3, wherein the GPS enabled device is a vehicle.

6. A system as claimed in paragraph 1, wherein the pre-processing module is arranged to cluster received location data into a plurality of cluster centres.

7. A system as claimed in paragraph 6, wherein the pre-processing module is arranged to merge clusters of received location data in the event that the given cluster centres are within a predefined proximity to one another.

8. A system as claimed in paragraph 1, wherein the pre-processing module is arranged to class location data into fixed location categories and journey route categories.

9. A system as claimed in paragraph 8, wherein the pre-processing module is arranged to remove specific location data points in the event they have been classified as being part of a user journey route.

10. A system as claimed in paragraph 8, wherein the training module is arranged to train the machine learning algorithm by dividing fixed location categories into two groups, the first group comprising the most popular fixed location category and the second group comprising all remaining categories, in order to reduce data skewing during training.

11. A system as claimed in any paragraph 8, wherein the training module is arranged to train the machine learning algorithm to optimise the identification of local minima in the user data.

12. A system as claimed in paragraph 1, wherein the training module is arranged to split the set of correlated data into a training portion for training the machine learning algorithm and a verification portion for verifying the accuracy of the trained machine learning algorithm.

13. A system as claimed in paragraph 1, wherein the machine learning algorithm is arranged to output predicted location data and a confidence level associated with the prediction.

14. A mobile network bandwidth planning system comprising a predictive modelling system as claimed in paragraph 1.

15. A hybrid car battery charge management module comprising a predictive modelling system as claimed in paragraph 1.

16. A system for predicting location data from user textual data comprising:
an input for receiving user data, the user data comprising user textual data;
a machine learning algorithm arranged to predicted location data from an input textual query, the algorithm having been trained on a set of correlated data comprising user textual data and location data;
an output arranged to output the predicted location data for the user based on the received user textual data.

17. A mobile network bandwidth planning system comprising a system as claimed in paragraph 16.

18. A hybrid car battery charge management module comprising a system as claimed in paragraph 16.

19. A method of training a machine learning algorithm comprising:
receiving user data, the user data comprising user textual data and location data;
correlating user textual data with location data to form a set of correlated data;
using the set of correlated data to train a machine learning algorithm such that the algorithm is arranged to output predicted location data from an input textual query.

20. A non-transitory computer readable medium storing a program for controlling a computing device to carry out the method of paragraph 19.

1. A system for predicting location data from user textual data, the system comprising:
an input that receives user data, the user data comprising user textual data and location data;
a pre-processing module that clusters the location data into a plurality of cluster centers and that correlates the user textual data with the location data to form a set of correlated data; and
a training module that uses the set of correlated data to train a machine learning algorithm such that the algorithm outputs predicted location data from an input textual query.

2. (canceled)

3. The system of claim 1, wherein the user data is received from a device with a global positioning system (GPS).

4. The system of claim 3, wherein the device with the GPS is a mobile communications device.

5. The system of claim 3, wherein the device is a vehicle.

6. (canceled)

7. The system of claim 1, wherein the pre-processing module merges clusters of the location data when the cluster centers are within a predefined proximity to one another.

8. The system of claim 1, wherein the pre-processing module classifies location data into fixed location categories and journey route categories.

9. The system of claim 8, wherein the pre-processing module removes specific location data points if they have been classified as being part of a user journey route.

10. The system of claim 8, wherein the training module trains the machine learning algorithm by dividing fixed location categories into two groups, the first group comprising a most popular fixed location category and the second group comprising all remaining categories, in order to reduce data skewing during training.

11. The system of claim 8, wherein the training module trains the machine learning algorithm to optimize identification of local optima in the user data.

12. The system of claim 1, wherein the training module splits the set of correlated data into a training portion for training the machine learning algorithm and a verification portion for verifying accuracy of the trained machine learning algorithm.

13. The system of claim 1, wherein the machine learning algorithm outputs predicted location data and a confidence level associated with the predicted location data.

14. A mobile network bandwidth planning system comprising the system of claim 1.

15. A hybrid car battery charge management module comprising the system of claim 1.

16. A system for predicting location data from user textual data, the system comprising:
an input that receives user data, the user data comprising user textual data;
a pre-processing module that correlates the user textual data with location data to form a set of correlated data;
a training module that uses the set of correlated data to train a machine learning algorithm such that the algorithm outputs predicted location data from an input textual query; and
an output arranged to output the predicted location data for the user based on the received user textual data.

17. A mobile network bandwidth planning system comprising the system of claim 16.

18. A hybrid car battery charge management module comprising the system of claim 16.

19. A method of training a machine learning algorithm, the method comprising:
receiving user data, the user data comprising user textual data from a user calendar and location data;
clustering the location data into a plurality of cluster centers;
correlating the user textual data with the location data to form a set of correlated data;
using the set of correlated data to train a machine learning algorithm such that the algorithm outputs predicted location data from an input textual query.

20. A non-transitory computer readable medium storing a computer program comprising computer readable code for controlling a computing device to carry out the method of claim 19.

21-22. (canceled)
